(19) United States
(12) Patent Application Publication
(10) Pub. No.: US 2007/0211500 A1
(43) Pub. Date: Sep. 13, 2007

(54) DC-DC converter with direct driven synchronous rectifier

(75) Inventors: YT Leung, Hong Kong (HK); Tim Leung, Hong Kong (HK); Winson Cheung, Hong Kong (HK)

Correspondence Address: BACON & THOMAS, PLLC, 625 SLATERS LANE, FOURTH FLOOR, ALEXANDRIA, VA, 22314, US

(73) Assignee: HIPRO ELECTRONIC CO., LTD, Taipei Hsien (TW)

(21) Appl. No.: 11/365,512

(22) Filed: Mar. 2, 2006

(51) Int. Cl. H02M 3/335

(52) U.S. Cl. 363/22

(57) ABSTRACT

A DC-DC converter with a direct driven synchronous rectifier is disclosed, comprising: a DC-AC converter receiving a DC voltage; a transformer having one primary winding coupled to the DC-AC converter and at least two secondary windings; a synchronous rectifier having two transistors; and an output filter coupled to the synchronous rectifier, wherein the two transistors of the synchronous rectifier are driven by the two secondary windings of the transformer, respectively.

### BACKGROUND OF THE INVENTION

1. Field of the Invention

The present invention relates to a DC-DC converter, and more particularly to a DC-DC converter with a direct driven synchronous rectifier without self-resonance.

2. Description of the Related Art

A DC-DC converter is a power converting circuit that converts an input voltage waveform into another specified output voltage waveform. In many applications requiring a DC output, DC-DC converters are frequently used. DC-DC converters generally include a primary side and a secondary side with a transformer coupling the two sides together. Referring to FIG. 1, in a conventional arrangement, a DC-DC converter comprises: a DC-AC converter 1, a transformer 2 having one primary winding coupled to the DC-AC converter 1 and one secondary winding, a synchronous rectifier 3 coupled to the secondary winding of the transformer 2, and an output filter 4 coupled to the synchronous rectifier 3. The DC-AC converter 1 generally includes switching devices, such as MOS field-effect transistors (MOSFETs), that convert the DC input voltage to an AC voltage. The transformer 2 will transform the AC voltage to another AC voltage. The rectifier 3 will generate the desired DC voltage of the DC-DC converter and then the desired DC voltage is filtered and sent out via the output filter 4.

However, in the conventional configuration of a DC-DC converter with a direct driven synchronous rectifier, a technical problem “self-resonance” is found. Referring to FIG. 1 again for a schematic circuit configuration for a DC-DC converter of the prior art and FIG. 2 for signal waveforms corresponding to FIG. 1. In FIG. 1, when the power supply is turned off, the output choke current will freewheel through transistor Q106 in the direction shown as arrow A1 and a positive voltage Vds is developed across the drain and source of Q106. This voltage is at its maximum when Q106 is turning off. In a DC-DC converter with a direct driven synchronous rectifier, this positive drain to source voltage Vds is directly applied to the gate of transistor Q107. If the positive voltage Vds of Q106 is high enough, Q107 will be turned on, and the choke current will flow in the path shown as arrow A2 in the secondary side. Due to the transformer action, this can induce a current in the primary side through the bode diode of transistor Q103. This transfer of energy from the secondary side to the primary side will continue until the energy in the secondary side is not high enough to turn on Q107.

From FIG. 2, it can be seen that the effect of this reverse energy flow is that the drain to source voltage Vds of Q103 will oscillate between zero voltage when the body diode is on and a certain high voltage when the body diode is off. The certain high voltage may be higher than the normal operating voltage of Q103. Thus a higher rating power MOSFET is required to be used as Q103 to prevent Q103 from being damaged. Higher rating power MOSFET has larger on-resistance between the drain and source and the power loss is increased. Accordingly the energy conversion efficiency is reduced and the cost of the Q103 is increased.

There is a need, therefore, for a DC-DC converter with a direct driven synchronous rectifier without self-resonance.

### SUMMARY OF THE INVENTION

It is the main object of the present invention to provide a DC-DC converter with a direct driven synchronous rectifier without self-resonance.

To achieve the above purpose, in one preferred embodiment according to the present invention, the DC-DC converter with a direct driven synchronous rectifier comprises: a DC-AC converter receiving a DC voltage; a transformer having one primary winding coupled to the DC-AC converter and two secondary windings; a synchronous rectifier having two transistors and four resistors; and an output filter coupled to the synchronous rectifier, wherein the two transistors of the synchronous rectifier are driven by the two secondary windings of the transformer, respectively.

Preferably, the DC-AC converter comprises one capacitor and two transistors.

Preferably, the two transistors of said DC-AC converter are MOSFET transistors.

Preferably, the phase-difference between said two secondary windings of the transformer is 180 degree.

Preferably, the synchronous rectifier comprises four resistors and two transistors.

Preferably, the two transistors of the synchronous rectifier are MOSFET transistors.

Preferably, the output filter comprises one inductor and one capacitor.

This and other purposes and many advantages of the present invention are illustrated by the following detailed description of the present invention, and become clearer understood with reference to accompanying drawings.

### BRIEF DESCRIPTION OF THE DRAWINGS

FIG. 1 is a schematic circuit diagram for a DC-DC converter of the prior art;

FIG. 2 illustrates the signal waveforms corresponding to FIG. 1;

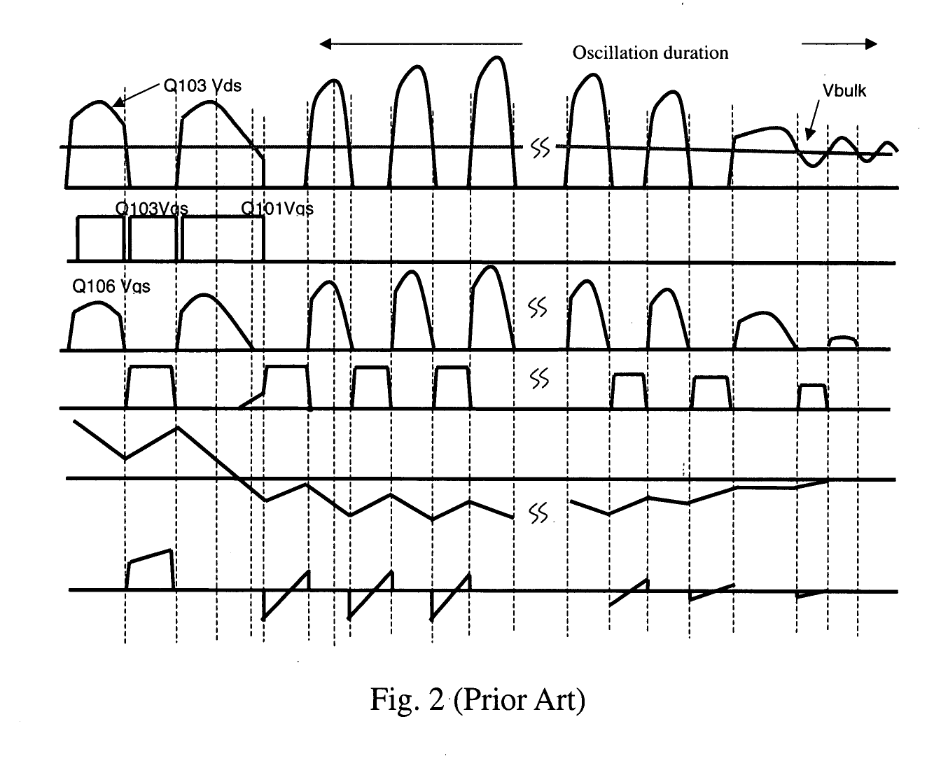

FIG. 3 is a schematic circuit diagram for a DC-DC converter of the present invention;

FIG. 4 illustrates the signal waveforms corresponding to FIG. 3; and

FIG. 5 is a schematic circuit diagram for another embodiment of a DC-DC converter of the present invention.

### DETAILED DESCRIPTION OF THE PREFERRED EMBODIMENTS

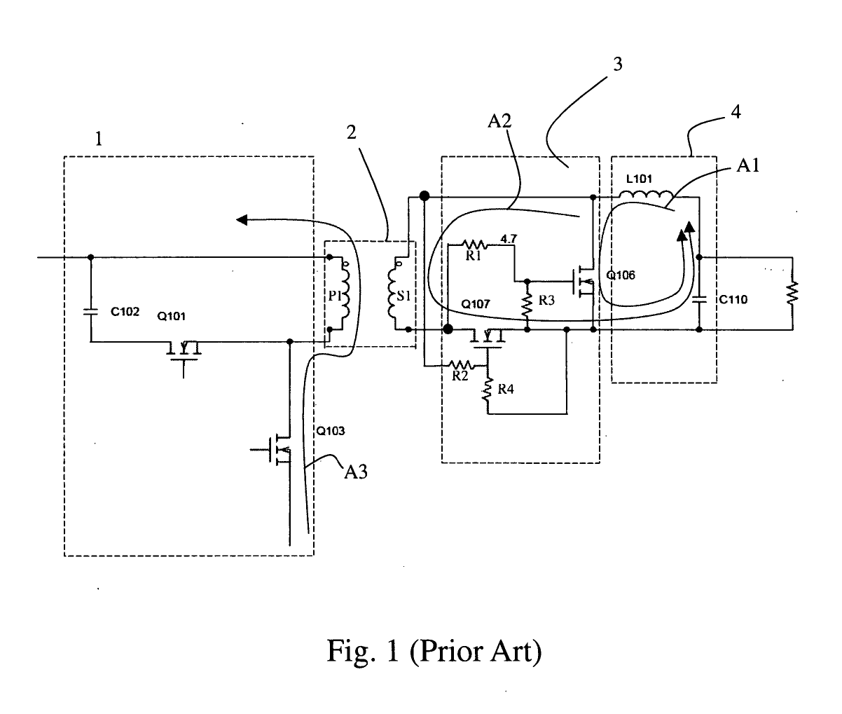

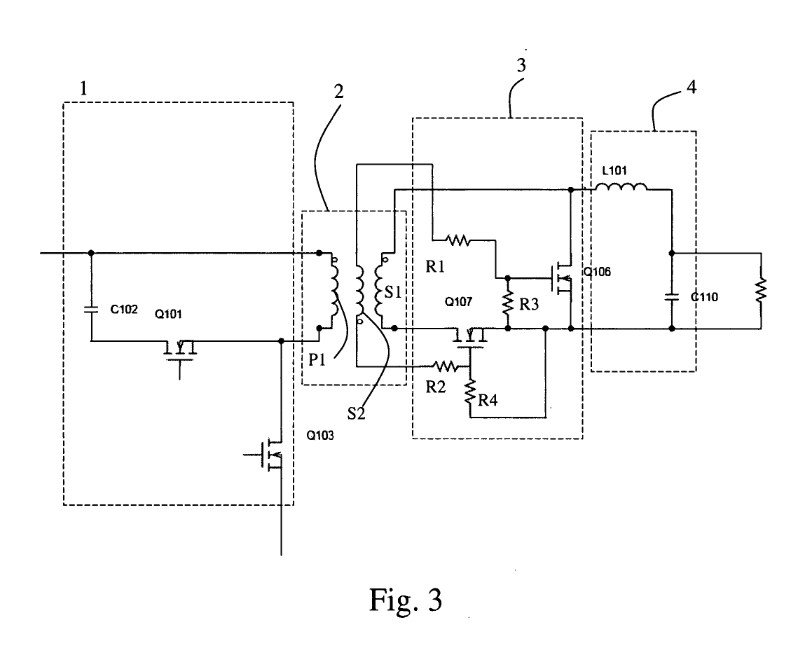

The configuration of the DC-DC converter with a direct driven synchronous rectifier according to the present invention is shown in FIG. 3, and parts the same as those in FIG. 1 are denoted by the same reference numerals.

It has to be emphasized that, the present configuration of the present invention differs from the prior art in that the transformer has one primary winding and at least two secondary windings, with this structure and correspondingly modified connections between the transformer and other elements of the DC-DC converter, the above-mentioned self-resonance problem is eliminated. Referring to FIG. 3, in the embodiment of the present invention, the DC-DC converter with a direct driven synchronous rectifier comprises a primary side and a secondary side with a transformer coupling the two sides together. In the present arrangement of the present invention, the DC-DC converter with a direct driven synchronous rectifier comprises: a DC-AC converter 1 receiving a DC voltage; a transformer 2 having one primary winding coupled to the DC-AC converter 1 and two secondary windings; a synchronous rectifier 3 having two transistors and four resistors; and an output filter 4 coupled to the synchronous rectifier 3, wherein the two transistors of the synchronous rectifier 3 are driven by the two secondary windings of the transformer 2, respectively.

In the DC-AC converter 1, one clamp capacitor C102 and two N-type MOSFET transistors Q101, Q103 are provided. One terminal of the clamp capacitor C102 is connected to one terminal of the primary winding P1 of the following transformer 2, and the other terminal of the clamp capacitor C102 is connected to the drain terminal of the transistor Q101. The source terminal of the transistor Q101 is connected to the drain terminal of the transistor Q103 and the other terminal of the primary winding P1 of the following transformer 2. Unlike conventional DC-DC converters, in the transformer 2 of the DC-DC converter with a direct driven synchronous rectifier according to the present invention as shown in FIG. 3, one primary winding P1 and two secondary windings S1, S2 are provided, such that the self-resonance will not happen. One terminal of the primary winding P1 is connected to one terminal of the clamp capacitor C102 in the DC-AC converter 1, and the other terminal of the primary winding P1 is connected to the source terminal of the transistor Q101 and the drain terminal of the transistor Q103. As to the first secondary winding S1, one terminal is connected to the drain terminal of the transistor Q106 of the following synchronous rectifier 3, and the other terminal is connected to the source terminal of the transistor Q107 of the following synchronous rectifier 3. As to the second secondary winding S2, one terminal is connected to one terminal of the resistor R1 of the following synchronous rectifier 3, and the other terminal is connected to one terminal of the resistor R2 of the following synchronous rectifier 3.

In the synchronous rectifier 3, four resistors R1, R2, R3, R4 and two N-type MOSFET transistors Q106, Q107 are provided. One terminal of the resistor R1 is connected to one terminal of the second secondary winding S2 of the transformer 2, the other terminal of the resistor R1 is connected to one terminal of the resistor R3 and the gate terminal of the transistor Q106. One terminal of the resistor R2 is connected to the other terminal of the second secondary winding S2 of the transformer 2, the other terminal of the resistor R2 is connected to one terminal of the resistor R4 and the gate terminal of the transistor Q107. The source terminal of the transistor Q107 is connected to one terminal of the first secondary winding S1 of the transformer 2, and the drain terminal of the transistor Q107 is connected to the other terminal of the resistor R3, the other terminal of the resistor R4, and the source terminal of the transistor Q106. The drain terminal of the transistor Q106 is connected to the other terminal of the first secondary winding S1 of the transformer 2 and one terminal of the inductor L101 of the following output filter 4.

In the output filter 4, one inductor L101 and one capacitor C110 are provided. One terminal of the inductor L101 is connected to one terminal of the first secondary winding S1 of the transformer 2 and the drain terminal of the transistor Q106 of the synchronous rectifier 3, the other terminal of the inductor L101 is connected to the capacitor C110. The other terminal of the capacitor C110 is connected to the other terminal of the resistor R3, the other terminal of the resistor R4, and the source terminal of the transistor Q106 of the synchronous rectifier 3.

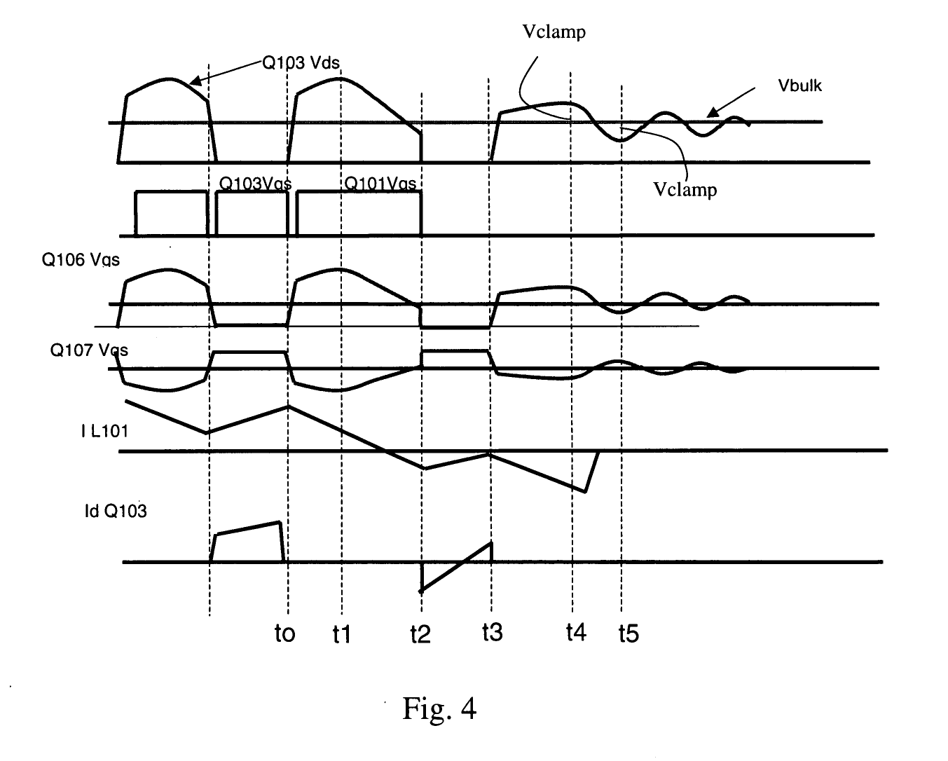

Referring to FIG. 3 again and in conjunction with FIG. 4, the operation of the DC-DC converter with a direct driven synchronous rectifier according to the present invention will be described now.

At time t0, when the power supply is turned off, the gate pulse of Q103 is turned off and the gate pulse of Q101 is still on.

From t0 to t1, the clamp capacitor C102 is charged up through Q101.

From t1 to t2, the clamp capacitor C102 is discharged and will transfer energy to the transformer 2.

At t2, the gate pulse of Q101 is turned off, and the magnetizing inductance and Coss capacitance of Q103 will form a resonating circuit and will discharge the Coss capacitance of Q103 to zero voltage and thus turn on the body diode of Q103.

When the current falls to zero at t3, the body diode current will stop conducting. The Vds of Q103 will rise to a voltage of Vbulk+Vclamp. And a resonant circuit is formed by the magnetizing inductance of the transformer 2 and the clamp capacitor C102.

The Vds voltage of Q103 will rise to the maximum at t4, and the current will attempt to reverse but is blocked by the body diode of Q103.

From t4 to t5, the Vds of Q103 may swing back to Vbulk due to the resonating of the magnetizing inductance of the transformer 2 and the Coss of Q103. The Vds will fall to a voltage of Vbulk−Vclamp, wherein the Vclamp is the voltage of C102 during t2 to t3.

At t5, the voltage across the transformer winding will equal to Vclamp, which is the maximum gate drive voltage applied to Q107. With proper arrangement, this voltage may be not enough to turn on Q107, such that the self-resonance in the secondary side will not be initiated.

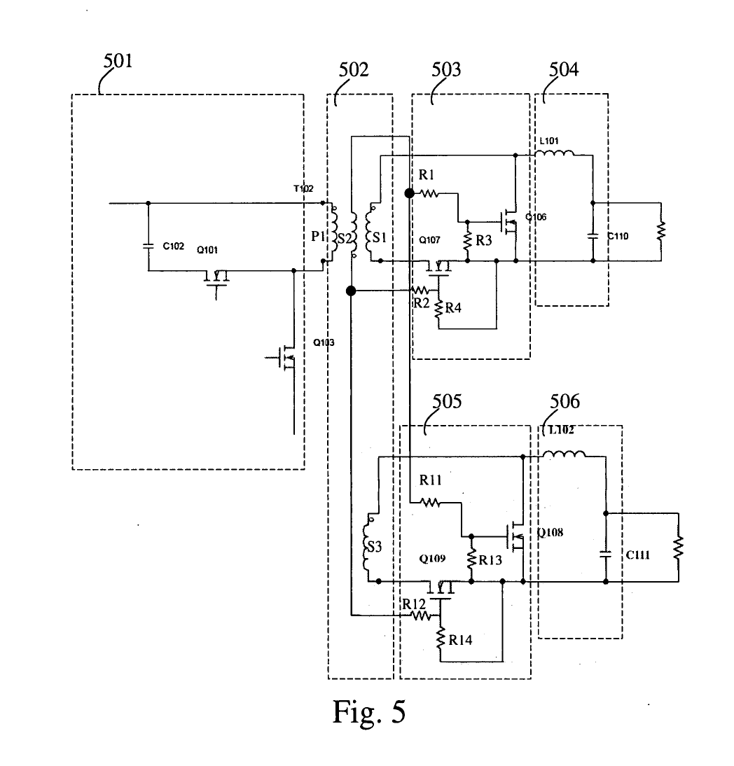

FIG. 5 is a schematic circuit diagram for another embodiment of a DC-DC converter of the present invention. In this figure, the DC-DC converter with a direct driven synchronous rectifier comprises a primary side and a secondary side with a transformer coupling the two sides together. In the present arrangement of the present invention, the DC-DC converter with a direct driven synchronous rectifier comprises: a DC-AC converter 501 receiving a DC voltage; a transformer 502 having one primary winding coupled to the DC-AC converter 501 and three secondary windings; two synchronous rectifiers 503 and 505, each having two transistors and four resistors; and two output filters 504 and 506 respectively coupled to the synchronous rectifiers 503 and 505, wherein the two transistors of the synchronous rectifiers 503 and 505 are respectively driven by the three secondary windings of the transformer 502, respectively.

In the DC-AC converter 501, one clamp capacitor C102 and two N-type MOSFET transistors Q101, Q103 are provided. One terminal of the clamp capacitor C102 is connected to one terminal of the primary winding P1 of the following transformer 2, and the other terminal of the clamp capacitor C102 is connected to the drain terminal of the transistor Q101. The source terminal of the transistor Q101 is connected to the drain terminal of the transistor Q103 and the other terminal of the primary winding P1 of the following transformer 2. In the transformer 502 of the DC-DC converter with a direct driven synchronous rectifier according to the present invention as shown in FIG. 5, one primary winding P1 and three secondary windings S1, S2, S3 are provided, such that the self-resonance will not happen. One terminal of the primary winding P1 is connected to one terminal of the clamp capacitor C102 in the DC-AC converter 501, and the other terminal of the primary winding P1 is connected to the source terminal of the transistor Q101 and the drain terminal of the transistor Q103. As to the first secondary winding S1, one terminal is connected to the drain terminal of the transistor Q106 of the following synchronous rectifier 503, and the other terminal is connected to the source terminal of the transistor Q107 of the following synchronous rectifier 503. As to the second secondary winding S2, one terminal is connected to one terminal of the resistor R1 of the following synchronous rectifier 503 and one terminal of the resistor R11 of the following synchronous rectifier 505, and the other terminal is connected to one terminal of the resistor R2 of the following synchronous rectifier 503 and one terminal of the resistor R12 of the following synchronous rectifier 505. As to the third secondary winding S3, one terminal is connected to the drain terminal of the transistor Q108 of the following synchronous rectifier 505, and the other terminal is connected to the source terminal of the transistor Q109 of the following synchronous rectifier 505.

In the synchronous rectifier 503, four resistors R1, R2, R3, R4 and two N-type MOSFET transistors Q106, Q107 are provided. One terminal of the resistor R1 is connected to one terminal of the second secondary winding S2 of the transformer 502, the other terminal of the resistor R1 is connected to one terminal of the resistor R3 and the gate terminal of the transistor Q106. One terminal of the resistor R2 is connected to the other terminal of the second secondary winding S2 of the transformer 502, the other terminal of the resistor R2 is connected to one terminal of the resistor R4 and the gate terminal of the transistor Q107. The source terminal of the transistor Q107 is connected to one terminal of the first secondary winding S1 of the transformer 502, and the drain terminal of the transistor Q107 is connected to the other terminal of the resistor R3, the other terminal of the resistor R4, and the source terminal of the transistor Q106. The drain terminal of the transistor Q106 is connected to the other terminal of the first secondary winding S1 of the transformer 502 and one terminal of the inductor L101 of the following output filter 504.

In the synchronous rectifier 505, four resistors R11, R12, R13, R14 and two N-type MOSFET transistors Q108, Q109 are provided. One terminal of the resistor R11 is connected to one terminal of the second secondary winding S2 of the transformer 502, the other terminal of the resistor R11 is connected to one terminal of the resistor R13 and the gate terminal of the transistor Q108. One terminal of the resistor R12 is connected to the other terminal of the second secondary winding S2 of the transformer 502, the other terminal of the resistor R12 is connected to one terminal of the resistor R14 and the gate terminal of the transistor Q109. The source terminal of the transistor Q109 is connected to one terminal of the third secondary winding S3 of the transformer 502, and the drain terminal of the transistor Q109 is connected to the other terminal of the resistor R13, the other terminal of the resistor R14, and the source terminal of the transistor Q108. The drain terminal of the transistor Q108 is connected to the other terminal of the third secondary winding S3 of the transformer 502 and one terminal of the inductor L102 of the following output filter 506.

In the output filter 504, one inductor L101 and one capacitor C110 are provided. One terminal of the inductor L101 is connected to one terminal of the first secondary winding S1 of the transformer 502 and the drain terminal of the transistor Q106 of the synchronous rectifier 503, the other terminal of the inductor L100 is connected to the capacitor C110. The other terminal of the capacitor C110 is connected to the other terminal of the resistor R3, the other terminal of the resistor R4, and the source terminal of the transistor Q106 of the synchronous rectifier 503.

In the output filter 506, one inductor L102 and one capacitor C111 are provided. One terminal of the inductor L102 is connected to one terminal of the third secondary winding S3 of the transformer 502 and the drain terminal of the transistor Q108 of the synchronous rectifier 505, the other terminal of the inductor L102 is connected to the capacitor C111. The other terminal of the capacitor C111 is connected to the other terminal of the resistor R13, the other terminal of the resistor R14, and the source terminal of the transistor Q108 of the synchronous rectifier 505. Although the present invention has been described in considerable detail with reference to certain preferred embodiments thereof, those skilled in the art can easily understand that all kinds of alterations and changes can be made within the spirit and scope of the appended claims. For example, the embodiments of the transformer of the DC-DC converter with a direct driven synchronous rectifier according to the present invention are described herein with respect to one primary winding and two secondary windings (FIG. 3) and one primary winding and three secondary windings (FIG. 5), however, the transformer can also have one primary winding and more than three secondary windings provided that the connections between these secondary windings and other elements of the DC-DC converter are correspondingly modified and the self-resonance is eliminated. Moreover, the transistors (Q101, Q103, Q106, Q107, Q108, Q109) are described as N-type MOSFET transistors, however, P-type MOSFET transistors can also be used as these transistors. Therefore, the spirit and scope of the present disclosure should not be limited to the description of the preferred embodiments and be limited only by the appended claims.

1. A DC-DC converter with a direct driven synchronous rectifier, which comprises, in cascade:
a DC-AC converter receiving a DC voltage;
a transformer having one primary winding coupled to the DC-AC converter and two secondary windings;
a synchronous rectifier having two transistors; and
an output filter coupled to said synchronous rectifier;
wherein said two transistors of the synchronous rectifier are driven by said two secondary windings of the transformer, respectively.

2. The DC-DC converter with a direct driven synchronous rectifier as claimed in claim 1, wherein said DC-AC converter comprises one capacitor and two transistors.

3. The DC-DC converter with a direct driven synchronous rectifier as claimed in claim 2, wherein said two transistors of said DC-AC converter are MOSFET transistors.

4. The DC-DC converter with a direct driven synchronous rectifier as claimed in claim 1, wherein a phase-difference between said two secondary windings of the transformer is 180 degrees.

5. The DC-DC converter with a direct driven synchronous rectifier as claimed in claim 1, wherein said synchronous rectifier comprises four resistors and two transistors.

6. The DC-DC converter with a direct driven synchronous rectifier as claimed in claim 5, wherein said two transistors are MOSFET transistors.

7. The DC-DC converter with a direct driven synchronous rectifier as claimed in claim 1, wherein said output filter comprises one inductor and one capacitor.

8. A DC-DC converter with a direct driven synchronous rectifier, which comprises, in cascade:
a DC-AC converter receiving a DC voltage;
a transformer having a first winding coupled to the DC-AC converter, a second winding with two terminals and a third winding with two terminals;
a synchronous rectifier having
a first field-effect transistor, whose drain is coupled to one terminal of said third winding, and whose gate is coupled to one terminal of said second winding, and
a second field-effect transistor whose drain is coupled to the other terminal of said third winding, whose gate is coupled to the other terminal of said second winding, and whose source is connected to the source of said first field-effect transistor; and
an output filter coupled to said synchronous rectifier.

9. The DC-DC converter with a direct driven synchronous rectifier as claimed in claim 8, wherein a phase-difference between said second and third windings of said transformer is 180 degrees.

10. The DC-DC converter with a direct driven synchronous rectifier as claimed in claim 8, wherein said first winding is a primary winding of the transformer, and said second and third windings are secondary windings of said transformer.

11. A DC-DC converter with a direct driven synchronous rectifier, which comprises, in cascade:
a DC-AC converter receiving a DC voltage;
a transformer having a first winding coupled to the DC-AC converter, a second winding and a plurality of third windings;
a plurality of synchronous rectifiers, each synchronous rectifier having two transistors; and
a plurality of output filters, each output filter coupled to a corresponding said synchronous rectifier.

12. The DC-DC converter with a direct driven synchronous rectifier as claimed in claim 11, wherein a phase-difference between said second winding and said third windings of said transformer is 180 degrees.

13. The DC-DC converter with a direct driven synchronous rectifier as claimed in claim 11, wherein said first winding is a primary winding of the transformer, and said second and third windings are secondary windings of said transformer.

14. The DC-DC converter with a direct driven synchronous rectifier as claimed in claim 11, wherein said two transistors of each synchronous rectifier are driven by said second winding and a corresponding said third winding of said transformer, respectively.
